(19) United States
(12) Patent Application Publication
(10) Pub. No.: US 2007/0063015 A1
(43) Pub. Date: Mar. 22, 2007

(54) Payment transaction system and method

(75) Inventor: Robert Mebruer, Hong Kong (CN)

Correspondence Address: SUGHRUE MION, PLLC, 2100 PENNSYLVANIA AVENUE, N.W., SUITE 800, WASHINGTON, DC, 20037, US

(73) Assignee: Prime King Investments Ltd.

(21) Appl. No.: 10/568,546

(22) PCT Filed: Aug. 18, 2004
(86) PCT No.: PCT/SG04/00250

§ 371 Date: Jul. 14, 2006

(30) Foreign Application Priority Data
Aug. 18, 2003 (AU) 2003-904428

(51) Int. Cl. G07F 19/00

(52) U.S. Cl. 235/379

(57) ABSTRACT

A payment transaction system and method is disclosed which has a central facility (100, 200) which has an approval payment processor and a transaction payment database for maintaining accounts relating to customers. The approval payment processor interrogates the database to determine whether a payment should be improved based on the status of the account. A retail processor (P1) receives input payment data from a consumer's mobile telephone relating to the purchase of products so that the payment data can be received by the central facility for approval or declining the payment. The retail processor (P1) has an EPOS checkout terminal and a store database and communicates with a retailer head office processor. The mobile phone is provided with a preset template for facilitating input of data.

### FIELD OF THE INVENTION

This invention relates to a payment transaction system and method.

### BACKGROUND OF THE INVENTION

Many electronic forms of payment are now in existence.

Such systems include the use of debit and credit cards which are used to make payments by electronically debiting a bank account or a credit account.

To simplify the manner in which payments are made, proposals have been made to make payments by way of a mobile or cellular telephone. These methods basically relate to integrated voice response processes, in which the consumer uses the phone and is interrogated by a system to input prompts by voice. These known proposals have two main problems, namely time sensitivity and non-interoperability. Thus, integrated voice response processes take too long to be an advantage to either the purchaser or the seller or are frustrating to both. Similarly, SMS messaging may have time lag issues if SMS messaging is used instead of voice prompt techniques. Non-interoperability may also be an issue because different cellular networks operate in various countries, and these different networks can employ different technology platforms that are not necessarily interoperable with each other, thereby compounding the time lag issue of payment transactions, especially when a person is not within their usual national jurisdiction.

### OBJECT OF THE INVENTION

The object of the present invention is to provide a system and method which makes payments by means of a communication device such as a mobile phone easier.

### SUMMARY OF THE INVENTION

The invention provides a payment transaction system comprising:
a receiver processor for receiving payment details from a consumer's communication device, the device being provided with a template for input of information by the consumer to allow the consumer to input payment data into the communication device relating to the payment which is to be made; and
a central facility for maintaining an account relating to the consumer and for receiving the payment data from the receiver processor for authorising the payment or declining the payment and for supplying a signal to the receiver processor which indicates whether the payment is authorised or declined.

Thus, according to the invention, because the receiver processor receives the data which is input in accordance with a template into the communication device, the data is received in a specific format, enabling the data to be received and forwarded to the central facility and retailer processor for authorising the payment and to allow settlement to take place between the central facility and the retailer. Thus, the system is not subject to time lag which is associated with voice prompts or non-interoperability because of various different operating platforms. Thus, payments are much quicker and easier to make.

Preferably the system further comprises a retailer processor coupled to the receiver processor and/or the central facility for storing details of payments made by the consumer to enable a retailer to reconcile payments made by the consumer with funds supplied from the central facility.

A first embodiment of the invention relates to face-to-face payments where a consumer makes payments when presenting with goods at the checkout at a retail store.

In this embodiment of the invention, the receiver processor comprises a store EPOS checkout terminal, the terminal having apparatus for receiving a signal from the communication device which transmits the payment data from the communication device to the receiver processor.

Preferably the central facility comprises a server which includes an account transaction payment database for maintaining account details relating to the consumer, and an approval processor for receiving the payment data relating to the payment, and for approving or declining the payment based on the status of the consumer's account as maintained in the account transaction payment database.

Preferably the retailer processor has a store back office server coupled to the EPOS terminal, the store back office server having a store database.

Preferably the retailer processor has a communication transmission processor and a transaction payment database, and wherein the receiver processor and the retailer processor are coupled together by a communication link.

Preferably the transmission processor is connected by a fixed line to the central facility server for transmitting the payment data to the central facility server and for receiving via a fixed line an indication as to whether the payment is approved or declined, so that if the payment is approved, the approval can be updated in the transaction payment database, the central facility processor also being for supplying to the store back office server an indication that the payment is approved or declined for in turn supply to the EPOS checkout terminal, so that a transaction associated with the payment can proceed if the payment is approved, or cease if the payment is declined.

Preferably the transmission processor comprises a modem for supplying the payment data via the fixed line to the approval processor.

Preferably a single fixed line supplies the payment data from the modem to the approval processor and the approval or decline data from the approval processor to the retailer's head office server.

In one embodiment, the apparatus for receiving the payment data from the communication device comprises a cradle in which the communicator device can sit so the data is transmitted by contact between the communicator device and the cradle.

In other embodiments, the apparatus may comprise an infrared detector for infrared communication between the communicator and the apparatus.

In a still further embodiment, the apparatus may be an apparatus for receiving blue-tooth communication from the communication device so the payment data is transmitted from the communication device to the EPOS checkout terminal.

Preferably the communication device comprises a mobile telephone.

In a still further embodiment of the invention, rather than the consumer presenting at the EPOS checkout terminal to make payment via the mobile telephone, the payment may be made by way of telephone call to the central authority, so the payment is a non-face-to-face payment.

In this embodiment, the receiver processor receives the payment data via the central facility after the central facility has processed the payment data and indicated approval of the payment, the central facility supplying an approval code from the central facility via a fixed line to the receiver processor, and the receiver processor supplying the payment data via a communication link to the retailer processor.

Preferably the receiver processor comprises a store back office server having a payment application processor and a store database, an EPOS store collection point coupled to the store back office server, the payment data being received by the store back office server so the store database can be updated in respect of the approved payment, and the payment processor being for transmitting an approval signal containing an approval code to the EPOS collection point, the central facility confirming approval of payment to the consumer by transmission of an approval code to the communication device of the consumer, so that when the consumer presents at the collection point, the approval code is matched with the approval code stored at the collection point to confirm payment so the consumer can collect the goods or services at the collection point.

Preferably the retailer processor comprises a retailer head office server having a transaction payment database for storing details of the payment which is approved by communication of a further communication link from the store back server to the retailer head office server so that the payment approval can be updated in the transaction payment database.

The invention also provides a payment transaction system comprising:
a first processor having an apparatus for receiving payment data from a communication device belonging to a consumer to enable payment to be made for goods or services, an EPOS checkout terminal, and a store back office server having a store database connected to the EPOS checkout terminal;
a retailer processor having a communication transmission processor and a transaction payment database;
a first communication link connecting the receiver processor to the retailer processor;
a central facility having a payment approval processor and an account transaction payment database, the account transaction database maintaining a database of accounts relating to consumers so that the processor can interrogate the database and determine whether a payment is to be approved or declined;
a second communication link for connecting the retailer processor to the central facility so that the payment data can be transmitted from the retailer head office server to the payment approval processor, and for transmitting a signal back from the central facility to the head office server indicating that payment is approved to enable updating of the transaction payment database of the retail head office server;
a third communication link for communicating the central facility with the receiver processor for enabling an indication of the approval of the payment to be transmitted from the central facility to the receiver processor so that the EPOS checkout terminal is provided with an indication that payment is approved to enable a consumer to receive the goods or services relating to the payment.

Preferably the central facility is also for transmitting a signal to the communication device of the consumer indicating that payment is approved.

Preferably the signal is an SMS message.

Preferably the communication device is provided with a preset template which is downloaded to facilitate the input of information by the consumer into the mobile telephone relating to the payment so the mobile telephone can transfer the payment data to the receiver processor.

Preferably the receiver processor includes an EDC (Electronic Data Capture) machine or cradle for receiving the mobile telephone transmission or mobile telephone to enable the transfer of the payment information to the receiver processor.

In other embodiments, the transfer from the mobile telephone may be by way of infrared communication or blue-tooth communication.

Preferably the communication device comprises a mobile telephone.

Preferably the second communication link comprises at least one fixed line for connecting the modem to the central facility.

The first and third communication links may comprise a common communication network interconnecting the receiver processor, the retailer processor and the central facility.

The invention still further provides a payment transaction system comprising:
a central facility having a payment approval processor and a transaction payment database, the database maintaining accounts relating to respective consumers, and the payment approval processor being for interrogating the database and determining whether a payment is to be approved based on the status of the consumers account, as maintained in the database, the central facility being for receiving payment data from a communication device belonging to a consumer, and if payment is to be approved for transmitting an approval code back to the communication device;
a receiver processor associated with a retail outlet for receiving an approval signal including the approval code from the central facility, the receiver processor including a store back office server having a payment application processor and a store database, the store database being for storing the approved payment, and an EPOS collection point for receiving from the payment application processor the approval code and for storing the approval code, so that when the consumer presents at the collection point to collect goods or services paid for, the approval code transmitted to the user's communication device and the stored approval code at the collection point are matched to confirm payment;
a communication link for communicating the central facility with the receiver processor;
a retail head office server including a payment database for receiving from the store back office server approval payment details for storing the payment transaction details to enable reconciliation of payments with the central facility; and
a second communication link for connecting the store back office server with the retailer head office server.

Preferably the first communication link comprises a fixed line communication link.

Preferably the payment application processor of the store back office server communicates with the EPOS collection point via a store communication network.

Preferably the communication device is provided with a preset template for downloading to facilitate the input of data by the consumer to form the payment data supplied to the central facility.

The invention also provides a payment transaction method comprising:
receiving payment details from a consumer's communication device, the device being provided with a template for input of information by the consumer to allow the consumer to input payment data into the communication device relating to the payment which is to be made; and
providing a central facility for maintaining an account relating to the consumer and for receiving the payment data for authorising the payment or declining the payment and for supplying a signal to the receiver processor which indicates whether the payment is authorised or declined.

Preferably the method further comprises storing details of payments made by the consumer to enable a retailer to reconcile payments made by the consumer with funds supplied from the central facility.

Preferably the step of receiving payment data comprises receiving the data by a store EPOS checkout terminal, the terminal having apparatus for receiving a signal from the communication device which transmits the payment data from the communication device to the receiver processor.

Preferably the central facility maintains an account transaction payment database for maintaining account details relating to the consumer, and an approval processor is used to receive the payment data relating to the payment, and for approving or declining the payment based on the status of the consumer's account as maintained in the account transaction payment database.

Preferably the method further comprises maintaining a store back office server having a store database.

Preferably the payment data is transmitted by a fixed line to the central facility for transmitting the payment data to the central facility server and for receiving via a fixed line an indication as to whether the payment is approved or declined, so that if the payment is approved, the approval can be updated in the transaction payment database, and supplying from the central facility to the store back office server an indication that the payment is approved or declined for in turn supply to the EPOS checkout terminal, so that a transaction associated with the payment can proceed if the payment is approved, or cease if the payment is declined.

Preferably a modem is used to supply the payment data via the fixed line to the approval processor.

Preferably a single fixed line supplies the payment data from the modem to the approval processor and the approval or decline data from the approval processor to the retailer's head office server.

In one embodiment, the method supplies the payment data from the communication device via an EDC (Electronic Data Capture) machine or cradle in which the communicator device can sit so the data is transmitted by contact between the communicator device and the EDC machine or cradle.

In other embodiments, the payment data is supplied by infrared communication. In a still further embodiment, payment data is supplied by blue-tooth communication from the communication device so the payment data is transmitted from the communication device to the EPOS checkout terminal.

Preferably the supply of payment data is from a mobile telephone.

In another embodiment, the payment data is provided to a retail store via the central facility after the central facility has processed the payment data and indicated approval of the payment, the central facility supplying an approval code from the central facility via a fixed line.

Preferably the payment data is received by a store back office server so a store database can be updated in respect of the approved payment, transmitting an approval signal containing an approval code to an EPOS collection point, the central facility confirming approval of payment to the consumer by transmission of an approval code to the consumer, so that when the consumer presents at the collection point, the approval code is matched with the approval code stored at the collection point to confirm payment so the consumer can collect the goods or services at the collection point.

Preferably the method maintains a transaction payment database for storing details of the payment which is approved by communication of a further communication link from the store back server so that the payment approval can be updated in the transaction payment database.

### BRIEF DESCRIPTION OF THE DRAWINGS

Preferred embodiment of the invention will be described, by way of example, with reference to the accompanying drawings in which:

FIG. 1 is a block diagram of a first embodiment of the invention for face-to-face payment transactions;

FIGS. 2A and 2B are diagrams of various retail stores using the embodiment of FIG. 1; and

FIG. 3 is a block diagram of a second embodiment of the invention for non-face-to-face payment transactions.

### DETAILED DESCRIPTION OF THE PREFERRED EMBODIMENTS

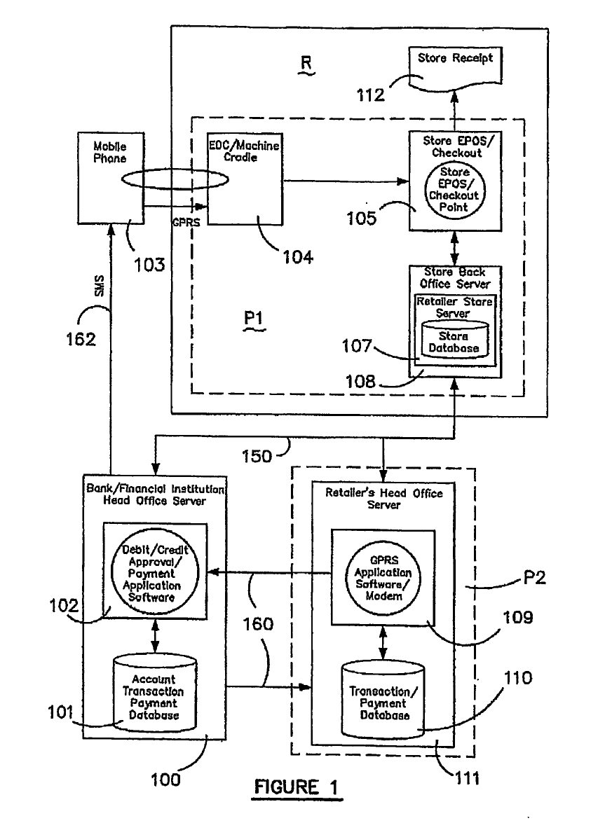

With reference to FIG. 1, a first embodiment of the invention will be described, in which payments are made face-to-face when the consumer presents at a checkout of a retail store.

In order to utilise the system and method according to the first embodiment of the invention, a consumer applies for a pre-approved credit/debit limit from a bank or financial institution which forms a central facility 100. The account which the consumer obtains may be a credit limit for purchases, or an account whereby the consumer is required to maintain funds and only draw down funds which are actually banked or otherwise saved by the consumer. Thus, the transactions can be in the nature of credit transactions or purely debit transactions against a consumer's bank account balance.

The central authority may typically be represented by a bank or other financial institution. The central facility 100 comprises an account transaction payment database 101 which maintains a database of all the account balances of the consumers operating the system. The central facility also includes an approval processor 102 which is programmed with debit/credit approval payment application software which can receive a request for payment and interrogate the database to determine whether the payment is to be authorised or to be declined based on the balance of the consumer's account and other data or information which is stored relating to the consumer and which is to be used by the central facility in order to make a determination whether to approve the payment or decline the payment.

When a consumer opens an account, the consumer is provided with an account number and a personal identification number (PIN). The consumer is also provided with a preset template which is supplied from the central facility 100 to a communication device, such as a mobile telephone 103, belonging to the consumer. The preset template is stored in the consumer's mobile telephone 103 and will assist the user in operating this system by organising input data which is to be supplied to enable a payment to be made, such as by following prompts or commands which may be displayed on a screen (not shown) of the mobile telephone 103.

Participating retailers who will offer the payment system and method are identified by the reference R in FIG. 1. Only one retailer is shown but typically, a number of separate retailers R will operate the system. The separate retailers R may be individual traders or may belong to a chain of retail outlets R operated by the same organisation.

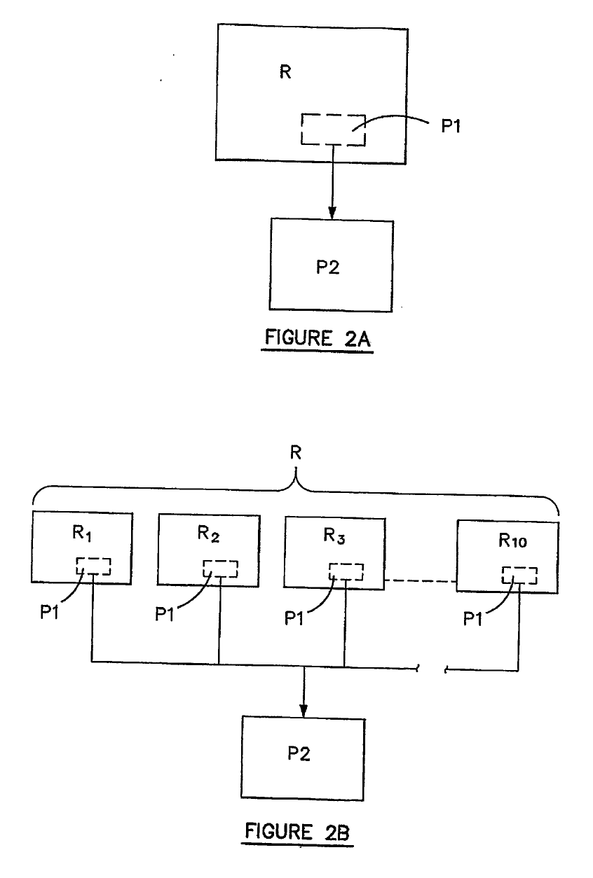

Each of the retail outlets R is provided with a receiver processor P1 for receiving input data from the consumer's mobile phone 103. Each individual retail outlet R or each chain of retail outlets R is provided with a retailer processor P2 at a retailer head office location. Thus, each sole retail outlet R will have a processor P2 which may be located at the premises of that retailer, as shown in FIG. 2A. However, if, for example, 10 different retail stores are operating in the same chain of retailers, those 10 retailers R₁ to R₁₀ (FIG. 2B) will have a common single processor P2 located at a head office location for that chain of retail outlets R.

The processor P1 and the processor P2 are connected to one another by a communication network 150. The communication network 150 also connects to the central facility 100.

Each processor P1 and each retail store R has a store EPOS checkout terminal 105 which is located in the store from which products may be purchased. The store also includes a store back office server 108 which is connected to the EPOS terminal 105. The server 108 has a store database 107 for maintaining details of all payment transactions associated with the particular retail outlet R.

The EPOS checkout terminal 105 and store back office server 108 communicate with the head office servers 111 via the communication network 150. The retailer's head office server 111 includes a GPRS application software modem 109 and a transaction payment database 110. The server 111 communicates with the central facility 110 via a fixed line or fixed lines 160 and also via the communication network 150.

When a consumer wishes to pay for goods at the retail outlet, the consumer presents at the EPOS checkout terminal 105 and the goods are processed at the terminal 105 in the usual manner. When the total balance payable is determined, the user locates his or her mobile phone 103 in EDC cradle 104 and downloads the preset template stored in the mobile telephone so the template is displayed on the screen of the mobile telephone. The consumer can then key in the account code/PIN and an amount payable according to the balance wrung up at the EPOS terminal 105 in accordance with the template which is displayed to the consumer. The consumer can then simply press “send” on the mobile telephone and the payment data will be sent via General Packet Radio Service (GPRS) to cradle 104 and then from the processor P1 to the processor P2. The communication may be via the terminal 105 and store back office server 108, and the communication network 150 to the head office server 111. Alternatively, the communication from the cradle 104 may be from some other retail network including the communication network 150 to the processor P2. The GPRS application software modem 109 will receive the payment data at the processor P2 and will forward the data to the central facility 100 via fixed line 160 so the data is received by the approval processor 102.

The approval processor 102 will then determine, based on the account balance in the database 101 associated with that consumer, and any other rules relating to that consumer, whether the payment is to be approved or declined. The signal indicating approval or declining of the payment is transmitted via line 160 back to retail head office server 111 so that a payment transaction record in transaction payment database 110 can be updated to show that a payment has been approved and notify the retailer of the assurance of payment for the goods the consumer is going to take. The central facility 100 also forwards via the network 150 the approval signal back to the store back office server 108 and then to the EPOS terminal 105 so the EPOS terminal 105 is provided with an immediate indication as to whether the approval is given or whether the transaction is to be declined. If the payment is approved, then the EPOS terminal 105 can print a store receipt 112 and the consumer can take the goods. If the payment is declined, then the transaction stops.

If approval takes place, the approval processor 102 will cause the balance relating to that consumer in the database 101 to be updated with that transaction. Thus, if payment is approved, the account balance is debited to reduce the balance, or the credit provided is increased in accordance with the payment.

The approval is also updated at the store database 107 associated with the server 108 so the store has a record of the actual transactions applicable to it, and at the end of each transaction day, the transactions from each of the retail stores R (such as R₁ to R₁₀) stored in the respective store databases 107 are uploaded to the retailer head office server 111 so the retailer server 111 knows which payments are associated with which of the retail outlets R₁ to R₁₀ operating the system. Thus, at the end of each transaction day, payments can be reconciled so that each retail outlet R and the retail head office know what payments are to be made to which of the retail outlets R.

The central facility 100 pays the retailer at the agreed terms and conditions to complete the full transaction cycle.

When the approval processor 102 approves the payment, the processor 102 also forwards an SMS message as indicated by line 162 direct to the consumer's mobile phone 103 informing the user that the payment has been approved.

In other embodiments, instead of using the EDC (Electronic Data Capture) machine or cradle 104 to receive the GPRS signal from the mobile phone 103, communication between the mobile phone 103 and the EPOS checkout terminal 105 may be by way of infrared signal or blue-tooth/GPRS communication.

In the case of infrared communication, IR devices associated with the mobile phone 103 and the EPOS terminal 105 will “discover” each other and develop an instance one-to-one communication. This will happen within range of each other and initiate the process of connection and accommodating exchange of information over the IR link between the mobile telephone 103 and the processor P1.

In the case of blue-tooth/GPRS communication, both the mobile telephone and the EPOS terminal devices must be blue-tooth enabled. When ready, the blue-tooth enabled mobile phone will send the input data input by the user via GPRS via a POS device at the checkout terminal 105.

Apart from the different communication of the input data from the mobile telephone to the processor P1, the system, when using infrared communication or blue-tooth/GPRS communication, operates the same as that previously described.

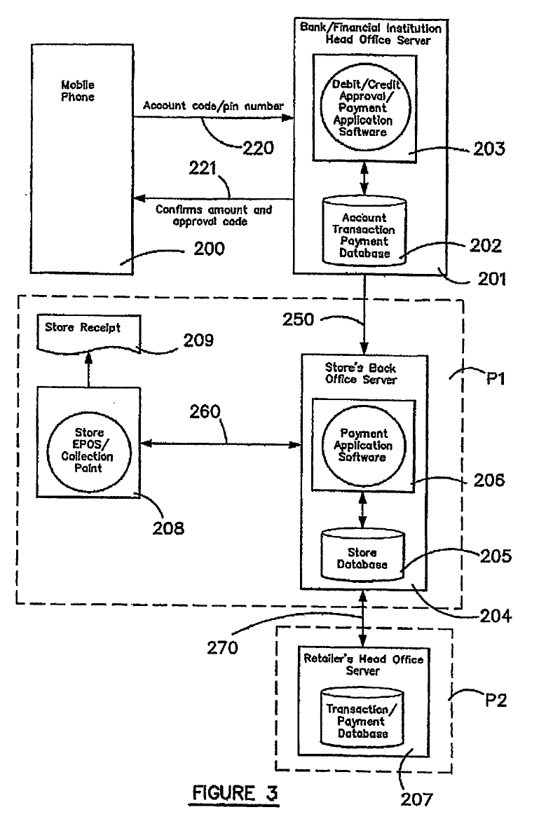

FIG. 3 is a diagram showing a second embodiment of the invention in which the payments are non-face-to-face payments. In this embodiment, an account is set up in exactly the same way as in the earlier embodiment, and the user's mobile phone 200 is provided with a preset template which is stored in the mobile phone to enable payments to take place.

When the consumer wishes to purchase goods, the consumer calls the central facility 201. On the preset template on the mobile phone 200, the user keys in his or her account code, PIN and participating retailer's account number to identify which retailer or store the consumer intends to make the purchase, and also a collection point from which goods, etc. will be collected. The collection point is provided with an EPOS terminal 208.

The input data provided by the consumer is transmitted by the mobile phone 200 as a telephone call, data communication or the like to the central facility 201.

The central facility 201 is the same as the central facility 100 previously described, which includes the approval processor 203 and the account transaction payment database 202. Thus, approval for the purchase or the declining of the payment of the purchase is made in the same manner as previously described. The approval is communicated from the central facility 201 via fixed line 250 to processor P1 at the particular retailer outlet R from which the goods are to be purchased. The processor P1 includes a store back office server 204 which includes a payment application processor 206 and a store database 205. The server 204 is connected to the EPOS terminal 208 associated with the retail outlet R via local communication network 260.

If approval for the payment is given, the central facility returns a signal back to the mobile telephone 200 by way of telephone call or data transmission which includes a confirmation of the approval and also an approval code, as is represented by arrow 221. The approval which is provided from the central facility 201 via the fixed line 250 also includes the amount and approval code so that the approval code is also received by the processor P1 at the retail store.

The server 204 is also connected to a retail head office server 207 via communication network 270 which may be a dedicated fixed line, internet communication network, or any other suitable local or wide area communication network. Once again, each of the retail outlets R operating the system and associated with a particular chain communicate with a single head office server 207 associated with that chain. Once again, if the payment is approved, the account balance relating to the user in the database 202 is updated.

When the central facility 201 sends via the fixed line 250 a signal to the store back office server 204 indicating that the transaction is approved (or declined), the store database 205 is updated to provide a record of the assurance to pay. The payment processor 206 communicates with the EPOS terminal 208 so that a standby transaction record is forwarded to the EPOS terminal 208, which includes the payment amount and the approval code.

When the consumer visits the EPOS terminal 208, the approval code is downloaded on the mobile phone and shown to the store personnel, who then calls up the standby transaction record and records the matching approval codes. A store receipt 209 is printed to confirm the transaction. The store EPOS terminal 208 updates the store database 205 via the link 260 to show that the transaction has been completed and the goods have been received. At the end of each transaction day, the store back office server 204 sends all data back to the head office server 207 which reconciles with the mobile payment transactions in the transaction payment database. The head office server 207 which, in this embodiment, forms the processor P2, also reconciles payments approved by the central facility so that settlement can take place with the central facility at the agreed terms and conditions to complete the full transaction cycle.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

1. A payment transaction system comprising:
a receiver processor for receiving payment details from a consumer's communication device, the device being provided with a template for input of information by the consumer to allow the consumer to input payment data into the communication device relating to the payment which is to be made; and
a central facility for maintaining an account relating to the consumer and for receiving the payment data from the receiver processor for authorising the payment or declining the payment and for supplying a signal to the receiver processor which indicates whether the payment is authorised or declined.

2. The system of claim 1 further comprising a retailer processor coupled to the receiver processor and/or the central facility for storing details of payments made by the consumer to enable a retailer to reconcile payments made by the consumer with funds supplied from the central facility.

3. The system of claim 2 wherein the receiver processor comprises a store EPOS checkout terminal, the terminal having apparatus for receiving a signal from the communication device which transmits the payment data from the communication device to the receiver processor.

4. The system of claim 1 wherein the central facility comprises a server which includes an account transaction payment database for maintaining account details relating to the consumer, and an approval processor for receiving the payment data relating to the payment, and for approving or declining the payment based on the status of the consumer's account as maintained in the account transaction payment database.

5. The system of claim 2 wherein the retailer processor has a store back office server coupled to the EPOS terminal, the store back office server having a store database.

6. The system of claim 5 wherein the retailer processor has a communication transmission processor and a transaction payment database, and wherein the receiver processor and the retailer processor are coupled together by a communication link.

7. The system of claim 6 wherein the transmission processor is connected by a fixed line to the central facility server for transmitting the payment data to the central facility server and for receiving via a fixed line an indication as to whether the payment is approved or declined, so that if the payment is approved, the approval can be updated in the transaction payment database, the central facility processor also being for supplying to the store back office server an indication that the payment is approved or declined for in turn supply to the EPOS checkout terminal, so that a transaction associated with the payment can proceed if the payment is approved, or cease if the payment is declined.

8. The system of claim 7 wherein the transmission processor comprises a modem for supplying the payment data via the fixed line to the approval processor.

9. The system of claim 7 wherein a single fixed line supplies the payment data from the modem to the approval processor and the approval or decline data from the approval processor to the retailer's head office server.

10. The system of claim 3 wherein the apparatus for receiving the payment data from the communication device comprises an EDC (Electronic Data Capture) machine or cradle in which the communicator device can sit, so the data is transmitted by contact between the communicator device and the EDC machine or cradle.

11. The system of claim 3 wherein the apparatus comprises an infrared detector for infrared communication between the communicator and the apparatus.

12. The system of claim 3 wherein the apparatus is for receiving blue-tooth communication from the communication device so the payment data is transmitted from the communication device to the EPOS checkout terminal.

13. The system of claim 1 wherein the communication device comprises a mobile telephone.

14. The system of claim 2 wherein the receiver processor receives the payment data via the central facility after the central facility has processed the payment data and indicated approval of the payment, the central facility supplying an approval code from the central facility via a fixed line to the receiver processor, and the receiver processor supplying the payment data via a communication link to the retailer processor.

15. The system of claim 1 wherein the receiver processor comprises a store back office server having a payment application processor and a store database, an EPOS store collection point coupled to the store back office server, the payment data being received by the store back office server so the store database can be updated in respect of the approved payment, and the payment processor being for transmitting an approval signal containing an approval code to the EPOS collection point, the central facility confirming approval of payment to the consumer by transmission of an approval code to the communication device of the consumer, so that when the consumer presents at the collection point, the approval code is matched with the approval code stored at the collection point to confirm payment so the consumer can collect the goods or services at the collection point.

16. The system of claim 1 wherein the retailer processor comprises a retailer head office server having a transaction payment database for storing details of the payment which is approved by communication of a further communication link from the store back server to the retailer head office server so that the payment approval can be updated in the transaction payment database.

17. A payment transaction system comprising:
a first processor having an apparatus for receiving payment data from a communication device belonging to a consumer to enable payment to be made for goods or services, an EPOS checkout terminal, and a store back office server having a store database connected to the EPOS checkout terminal;
a retailer processor having a communication transmission processor and a transaction payment database;
a first communication link connecting the receiver processor to the retailer processor;
a central facility having a payment approval processor and an account transaction payment database, the account transaction database maintaining a database of accounts relating to consumers so that the processor can interrogate the database and determine whether a payment is to be approved or declined;
a second communication link for connecting the retailer processor to the central facility so that the payment data can be transmitted from the retailer head office server to the payment approval processor, and for transmitting a signal back from the central facility to the head office server indicating that payment is approved to enable updating of the transaction payment database of the retail head office server;
a third communication link for communicating the central facility with the receiver processor for enabling an indication of the approval of the payment to be transmitted from the central facility to the receiver processor so that the EPOS checkout terminal is provided with an indication that payment is approved to enable a consumer to receive the goods or services relating to the payment.

18. The system of claim 17 wherein the central facility is also for transmitting a signal to the communication device of the consumer indicating that payment is approved.

19. The system of claim 18 wherein the signal is an SMS message.

20. The system of claim 17 wherein the communication device is provided with a preset template which is downloaded to facilitate the input of information by the consumer into the mobile telephone relating to the payment so the mobile telephone can transfer the payment data to the receiver processor.

21. The system of claim 17 wherein the receiver processor includes an EDC (Electronic Data Capture) machine or cradle for receiving the mobile telephone to enable the transfer of the payment information to the receiver processor.

22. The system of claim 17 wherein the communication device comprises a mobile telephone.

23. The system of claim 17 wherein the second communication link comprises at least one fixed line for connecting the modem to the central facility.

24. The system of claim 17 wherein the first and third communication links comprise a common communication network interconnecting the receiver processor, the retailer processor and the central facility.

25. a payment transaction system comprising:
a central facility having a payment approval processor and a transaction payment database, the database maintaining accounts relating to respective consumers, and the payment approval processor being for interrogating the database and determining whether a payment is to be approved based on the status of the consumers account, as maintained in the database, the central facility being for receiving payment data from a communication device belonging to a consumer, and if payment is to be approved for transmitting an approval code back to the communication device;
a receiver processor associated with a retail outlet for receiving an approval signal including the approval code from the central facility, the receiver processor including a store back office server having a payment application processor and a store database, the store database being for storing the approved payment, and an EPOS collection point for receiving from the payment application processor the approval code and for storing the approval code, so that when the consumer presents at the collection point to collect goods or services paid for, the approval code transmitted to the user's communication device and the stored approval code at the collection point are matched to confirm payment;
a communication link for communicating the central facility with the receiver processor;
a retail head office server including a payment database for receiving from the store back office server approval payment details for storing the payment transaction details to enable reconciliation of payments with the central facility; and
a second communication link for connecting the store back office server with the retailer head office server.

26. The system of claim 25 wherein the first communication link comprises a fixed line communication link.

27. The system of claim 25 wherein the payment application processor of the store back office server communicates with the EPOS collection point via a store communication network.

28. The system of claim 25 wherein the communication device is provided with a preset template for downloading to facilitate the input of data by the consumer to form the payment data supplied to the central facility.

29. A payment transaction method comprising:
receiving payment details from a consumer's communication device, the device being provided with a template for input of information by the consumer to allow the consumer to input payment data into the communication device relating to the payment which is to be made; and
providing a central facility for maintaining an account relating to the consumer and for receiving the payment data for authorising the payment or declining the payment and for supplying a signal to the receiver processor which indicates whether the payment is authorised or declined.

30. The method of claim 29 wherein the method further comprises storing details of payments made by the consumer to enable a retailer to reconcile payments made by the consumer with funds supplied from the central facility.

31. The method of claim 29 wherein the step of receiving payment data comprises receiving the data by a store EPOS checkout terminal, the terminal having apparatus for receiving a signal from the communication device which transmits the payment data from the communication device to the receiver processor.

32. The method of claim 29 wherein the central facility maintains an account transaction payment database for maintaining account details relating to the consumer, and an approval processor is used to receive the payment data relating to the payment, and for approving or declining the payment based on the status of the consumer's account as maintained in the account transaction payment database.

33. The method of claim 29 wherein the method further comprises maintaining a store back office server having a store database.

34. The method of claim 33 wherein the payment data is transmitted by a fixed line to the central facility for transmitting the payment data to the central facility server and for receiving via a fixed line an indication as to whether the payment is approved or declined, so that if the payment is approved, the approval can be updated in the transaction payment database, and supplying from the central facility to the store back office server an indication that the payment is approved or declined for in turn supply to the EPOS checkout terminal, so that a transaction associated with the payment can proceed if the payment is approved, or cease if the payment is declined.

35. The method of claim 34 wherein a modem is used to supply the payment data via the fixed line to the approval processor.

36. The method of claim 34 wherein a single fixed line supplies the payment data from the modem to the approval processor and the approval or decline data from the approval processor to the retailer's head office server.

37. The method of claim 29 wherein the method supplies the payment data from the communication device via an EDC (Electronic Data Capture) machine or cradle in which the communicator device can sit so the data is transmitted by contact between the communicator device and the cradle.

38. The method of claim 29 wherein the payment data is supplied by infrared communication.

39. The method of claim 29 wherein payment data is supplied by blue-tooth communication from the communication device so the payment data is transmitted from the communication device to the EPOS checkout terminal.

40. The method of claim 29 wherein the supply of payment data is from a mobile telephone.

41. The method of claim 29 wherein the payment data is provided to a retail store via the central facility after the central facility has processed the payment data and indicated approval of the payment, the central facility supplying an approval code from the central facility via a fixed line.

42. The method of claim 41 wherein the payment data is received by a store back office server so a store database can be updated in respect of the approved payment, transmitting an approval signal containing an approval code to an EPOS collection point, the central facility confirming approval of payment to the consumer by transmission of an approval code to the consumer, so that when the consumer presents at the collection point, the approval code is matched with the approval code stored at the collection point to confirm payment so the consumer can collect the goods or services at the collection point.

43. The method of claim 42 wherein the method maintains a transaction payment database for storing details of the payment which is approved by communication of a further communication link from the store back server so that the payment approval can be updated in the transaction payment database.
